(19) United States
(12) Patent Application Publication
(10) Pub. No.: US 2008/0060027 A1
(43) Pub. Date: Mar. 6, 2008

(54) METHOD AND APPARATUS FOR MANAGING TIME-SHIFTING AMONG A PLURALITY OF CHANNELS

(76) Inventor: Hsing-Yuan Yang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/550,800

(22) Filed: Oct. 19, 2006

(30) Foreign Application Priority Data
Sep. 4, 2006 (TW) 095132626

(51) Int. Cl. H04N 7/173

(52) U.S. Cl. 725/88; 725/102; 725/97

(57) ABSTRACT

A method for managing time-shifting includes buffering a first program using a first tuner while broadcasting the first program on a first channel, and buffering a second program using a second tuner while broadcasting the second program on a second channel after switching from the first channel to the second channel. If the first program has been broadcast longer than a predetermined period of time before switching channels, the method buffers the first program using the first tuner while broadcasting the second program on the second channel. If the first program has not been broadcast longer than the predetermined period of time before switching channels, the method stops buffering the first program while broadcasting the second program on the second channel.

### BACKGROUND OF THE INVENTION

1. Field of the Invention

The present invention relates to a method and an apparatus for managing time-shifting among a plurality of channels, and more particularly, to a method and an apparatus for managing time-shifting among a plurality of channels using tuners.

2. Description of the Prior Art

With rapid development in consumer electronic products, video entertainment products have become essential in daily life. For television sets widely available in household, only wireless television stations providing limited amounts of channels were available in the past. As technology progresses, cable televisions can offer consumers more than a hundred channels. Recently, digital televisions are gaining more and more attention due to more powerful functions and superior display quality.

With the widespread of television sets, the demand for corresponding peripheral equipments (such as video recorders) also increases. Video recorders have progressed from traditional video cassette recorders (VCR) into digital versatile disc (DVD) video recorders or personal video recorders (PVR). Video recorders also provide a wider variety of functions, such as setting the turn-on time, timer-recording, frame-division for viewing multiple programs simultaneously, and time-shifting.

Time-shifting is a useful function available in most video recorders. For example, if a user watches a live television program using a video recorder but has to leave for some reason, the current television program can be paused. The program broadcast during the user's absence can be stored. When the user returns, the video recorder can resume playing the program of interest from the exact point at which the program was paused. The user can thus watch the entire program, without missing any content. Also, if a user timer-records a designated program and returns home before the designated program ends, time-shifting allows the user to watch the previously-stored designated program immediately from the beginning, while buffering the currently-broadcasting designated program on a real time basis. The user can thus watch the designated program without waiting or further interruptions. When a user decides to record a program after watching it for a while, the previous program contents will still be available since time-shifting automatically stores the current program into the buffer of the video recorder. In addition, the user can retrieve contents of a program that have been previously broadcast while watching the current program on a real time basis, as well as execute operations such as rewind, fast-rewind, pause or play on the retrieved contents of the program.

Usually, a video recorder performs time-shifting by buffering programs using a stream buffer engine (SBE). Recent television systems provide tens or over a hundred channels for the audience. A user can watch a program of interest currently broadcast on a channel with time-shifting being activated. When the program of interest comes to a commercial break, the user usually switches to other channels. In anticipation of the end of the commercial break, the user will switch back to the original channel in order to resume watching the program of interest. In the prior art, time-shifting is not performed on the original channel after the user switches to a new channel. Instead, data previously stored in the SBE is erased for buffering programs broadcast on the new channel. However, when switching channels during the commercial breaks in the program of interest, the user merely wants to avoid some tedious and repetitive commercial clips instead of intending to watch programs broadcast on other channels. When the user switches back to the original channel, the program of interest broadcast before the commercial break can no longer be accessed since data previously stored in the SBE has been erased.

US Patent Publication No. US2006/0015914 discloses a recording method and apparatus capable of time-shifting in a plurality of channels. In this prior art, a user first sets a plurality of designated channels and activates the time-shifting function of these designated channels. Next, the user can watch a program broadcast on one of the designated channels while buffering programs broadcast on other designated channels simultaneously. If the user switches channels, data previous stored is erased according to a predetermined rule. In this prior art, the user is required to set the designated channels and only programs broadcast on these designated channels can be buffered. Also, if the user does not switch channels, time-shifting is still performed on multiple channels at the same time.

US Patent Publication No. US2002/0199185 discloses a time-shift buffer (TSB) capable of managing time-shifting. In this prior art, time-shifting is performed on a channel currently broadcasting a user's program of interest and the program of interest is stored in a TSB. Also, the user is required to input a control signal in order to allow or reject access to data stored in the TSB after switching channels. If the control signal is an enable signal, data stored in the TSB before switching channels can still be accessed after switching channels; if the control signal is a disable signal, data stored in the TSB before switching channels cannot be accessed after switching channels.

### SUMMARY OF THE INVENTION

The present invention provides a method for managing time-shifting among a plurality of channels comprising buffering a first program using a first tuner while broadcasting the first program on a first channel; buffering a second program using a second tuner while broadcasting the second program on a second channel after switching from the first channel to the second channel; determining whether the first program has been broadcast longer than a predetermined period of time; and buffering the first program using the first tuner while broadcasting the second program on the second channel if the first program has been broadcast longer than the predetermined period of time before switching from the first channel to the second channel.

The present invention also provides a multi-media display system capable of managing time-shifting among a plurality of channels comprising a broadcasting means for broadcasting programs on a plurality of channels; a first buffering means for buffering a first program broadcast on a first channel; a second buffering means for buffering a second program broadcast on a second channel; a judging means for determining whether the first program has been broadcast longer than a predetermined period of time before switching from the first channel to the second channel; and a control means for activating the first buffering means in order to buffer the first program after switching from the first channel to the second channel if the first program has been broadcast longer than the predetermined period of time before switching from the first channel to the second channel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a method for managing time-shifting using two tuners according to a first embodiment of the present invention.

FIG. 2 is a diagram illustrating data stored in the tuners in the first embodiment of the present invention.

FIG. 3 is a diagram illustrating data stored in the tuners in the first embodiment of the present invention.

FIG. 4 is a flowchart illustrating a method for managing time-shifting among a plurality of channels using a plurality of tuners according to a second embodiment of the present invention.

FIG. 5 is a flowchart illustrating a method for managing time-shifting among a plurality of channels using a plurality of tuners according to a third embodiment of the present invention.

FIG. 6 is a flowchart illustrating a method for managing time-shifting using two tuners according to a fourth embodiment of the present invention.

### DETAILED DESCRIPTION

Tuners have been widely applied in various consumer and commercial systems, such as televisions, video recorders, cable modems or cable set-top-boxes. A tuner can receive analog, digital or cable signals for multiple channels, pass required channel signals and exclude other unnecessary channel signals. In a multi-tuner video recorder, a plurality of tuners are used for receiving image data. If image data is somehow delayed or lost during transmission, data received by different tuners can be integrated before being displayed. Therefore, compared to single-tuner video recorders, multi-tuner video recorders can provide higher data integrity.

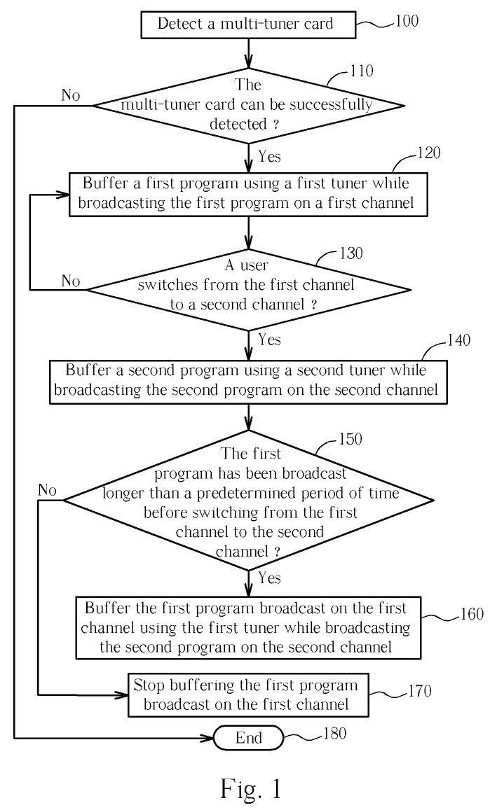

Reference is made to FIG. 1 for a flowchart illustrating a method for managing time-shifting using two tuners according to a first embodiment of the present invention. The flowchart in FIG. 1 includes the following steps:

Step 100: detect a multi-tuner card capable of controlling a plurality of tuners.

Step 110: determine whether the multi-tuner card can be successfully detected: if the multi-tuner card can be successfully detected, execute step 120; if the multi-tuner card cannot be successfully detected, execute step 180.

Step 120: buffer a first program using a first tuner while broadcasting the first program on a first channel; execute step 130.

Step 130: determine whether a user switches from the first channel to a second channel: if the user switches from the first channel to the second channel, execute step 140; if the user does not switch from the first channel to the second channel, execute step 120.

Step 140: buffer a second program using a second tuner while broadcasting the second program on a second channel; execute step 150.

Step 150: determine whether the first program has been broadcast longer than a predetermined period of time before switching from the first channel to the second channel: if the first program has been broadcast longer than the predetermined period of time before switching channels, execute step 160; if the first program has not been broadcast longer than the predetermined period of time before switching channels, execute step 170.

Step 160: buffer the first program broadcast on the first channel using the first tuner while broadcasting the second program on the second channel.

Step 170: stop buffering the first program broadcast on the first channel while broadcasting the second program on the second channel.

Step 180: end.

The first embodiment of the present invention can be applied to a dual-tuner video recorder in which two tuners are used for performing time-shifting on two channels. First, step 100 is executed for detecting a multi-tuner card, and step 110 is executed for determining whether the multi-tuner card can be successfully detected. The multi-tuner card is used for controlling the operation of each tuner. When the multi-tuner card can be successfully detected, the video recorder can correctly drive each tuner using the multi-tuner card.

Assuming the user is watching the first program broadcast on the first channel, step 120 is executed for performing time-shifting on the first channel so that the first program can be buffered using the first tuner. Therefore, the user can retrieve contents of the first program that have been previously broadcast while watching the current first program on a real time basis, as well as execute operations such as rewind, fast-rewind, pause or play on the retrieved contents of the first program.

When the current first program comes to a commercial break or the user does not want to continue watching the first program, the user may switch from the first channel to the second channel. Then, step 140 is executed for performing time-shifting on the second channel so that the second program can be buffered using the second tuner. Therefore, the user can retrieve contents of the second program that have been previously broadcast while watching the current second program on a real time basis, as well as execute operations such as rewind, fast-rewind, pause or play on the retrieved contents of the second program.

Also, after switching from the first channel to the second channel, step 150 is executed in order to determine whether the first program has been broadcast longer than the predetermined period of time before switching channels. If the first program has been broadcast longer than the predetermined period of time before switching channels, it means the first program is the user's primary viewing program. The user may switch back to the first channel and resumes watching the first program. In this case, the contents of the first program that have been broadcast or are being broadcast are important to the user, and step 160 is executed for continuing buffering the first program after switching channels. Under these circumstances, the first and second tuners are used for performing time-shifting on the first and second channels, respectively. On the other hand, if the first program has not been broadcast longer than the predetermined period of time before switching channels, it means the first program is not the user's primary viewing program. The reason that the first channel is selected is possibly because the user is switching channels during the commercial break of the primary viewing program. In this case, the contents of the first program that have been broadcast or are being broadcasting are of little significance to the user, and step 170 is executed for discontinuing buffering the first program after switching channels. Under these circumstances, only the second tuner is used for performing time-shifting on the second channel.

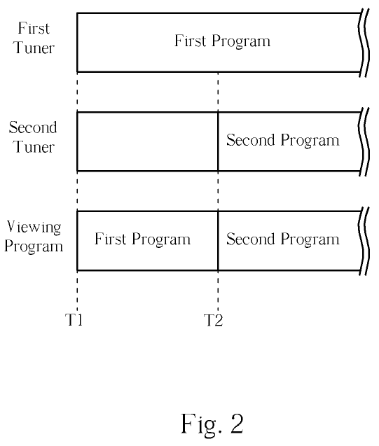

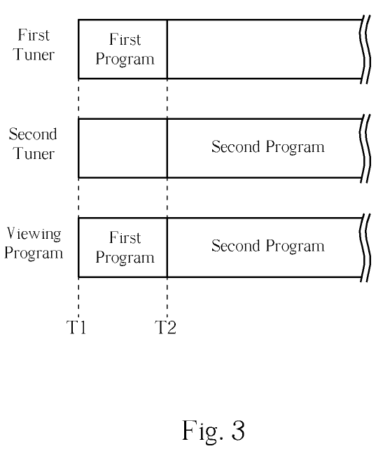

References are made to FIGS. 2 and 3 for diagrams illustrating data stored in the tuners in the first embodiment of the present invention. In FIGS. 2 and 3, the transverse axle represents time, and data stored in the first and second tuners are respectively illustrated. A blank space corresponds to the period during which the corresponding tuner is not performing time-shifting. If the user begins watching the first program at T1 and switches to the second channel at T2 for some reason, then the first tuner is used for buffering the first program during T1 and T2, while the second tuner is not performing time-shifting during this period. After switching from the first channel to the second channel, the present invention begins to buffer the second program using the second tuner at T2. At the same time, if the viewing time of the first program before switching channels (T2-T1) is larger than a predetermined value, the first program can be the user's main viewing program and the present invention continues to buffer the first program using the first tuner after T2, as illustrated in FIG. 2. On the other hand, if the viewing time of the first program before switching channels (T2-T1) is not larger than the predetermined value, the first program is not the user's main viewing program and the present invention stops buffering the first program using the first tuner at T2. In other words, the first tuner does not perform time-shifting after T2, as illustrated in FIG. 3.

In the first embodiment of the present invention, two tuners are used for performing time-shifting. One tuner is used for performing time-shifting on an original channel and the other is used for performing time-shifting on a new channel after switching channels. Also, the present invention determines whether time-shifting is performed on the original channel longer than a predetermined period of time. If the user is switching channels during the commercial breaks of the primary viewing program, time-shifting is performed on the original channel only for a short period of time before switching channels. It can therefore be determined that the user does not intend to watch the program broadcast on the original channel, and the present invention stops performing time-shifting on the original channel after switching channels. If the program broadcast on the original channel is the user's primary viewing program, time-shifting is performed on the original channel for a long period of time before switching channels. It can therefore be determined that the user is likely to switch back to the original channel, and the present invention continues to perform time-shifting on the original channel after switching channels.

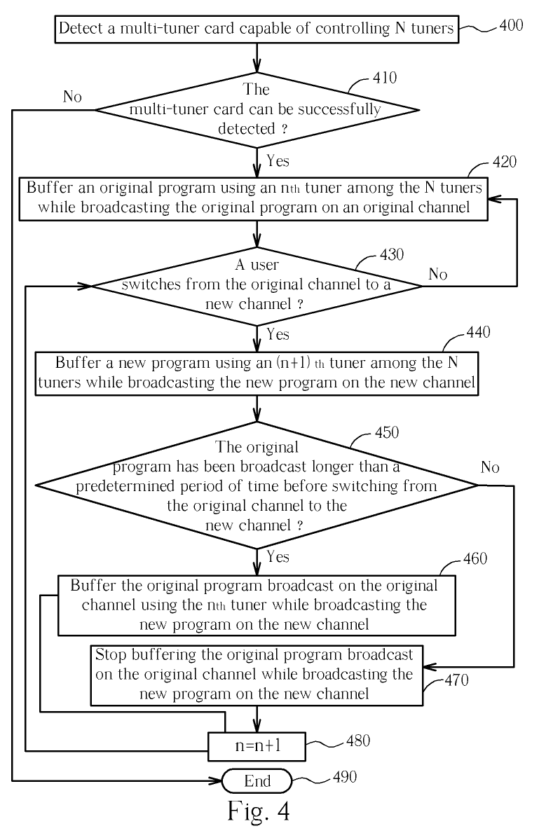

Reference is made to FIG. 4 for a flowchart illustrating a method for managing time-shifting among a plurality of channels using a plurality of tuners according to a second embodiment of the present invention. The flowchart in FIG. 4 includes the following steps:

Step 400: detect a multi-tuner card capable of controlling N tuners.

Step 410: determine whether the multi-tuner card can be successfully detected: if the multi-tuner card can be successfully detected, execute step 420; if the multi-tuner card cannot be successfully detected, execute step 490.

Step 420: buffer an original program using an nth tuner among the N tuners (n is an integer between 1 and N) while broadcasting the original program on an original channel.

Step 430: determine whether a user switches from the original channel to a new channel: if the user switches from the original channel to the new channel, execute step 440; if the user does not switch from the original channel to the new channel, execute step 420.

Step 440: buffer a new program using an (n+1)ₜₕ tuner among the N tuners while broadcasting the new program on the new channel; execute step 450.

Step 450: determine whether the original program has been broadcast longer than a predetermined period of time before switching from the original channel to the new channel: if the original program has been broadcast longer than the predetermined period of time before switching channels, execute step 460; if the original program has not been broadcast longer than the predetermined period of time before switching channels, execute step 470.

Step 460: buffer the original program broadcast on the original channel using the nth tuner while broadcasting the new program on the new channel.

Step 470: stop buffering the original program broadcast on the original channel while broadcasting the new program on the new channel.

Step 480: increase n by 1; execute step 430.

Step 490: end.

Instead of using two tuners as in the first embodiment of the present invention, the second embodiment of the present invention uses N tuners for managing time-shifting. In the second embodiment of the present invention, each time when the user switches from an original channel to a new channel and the program of the original channel has been broadcast longer than a predetermined period of time, one of the N tuners is used for buffering the program broadcast on the original channel. In other words, the second embodiment of the present invention can perform time-shifting on N channels simultaneously. Therefore, even if the user keeps switching channels, the user can still retrieve contents of the programs that have been previously broadcast on the N channels, as well as execute operations such as rewind, fast-rewind, pause or play on the retrieved contents of the program.

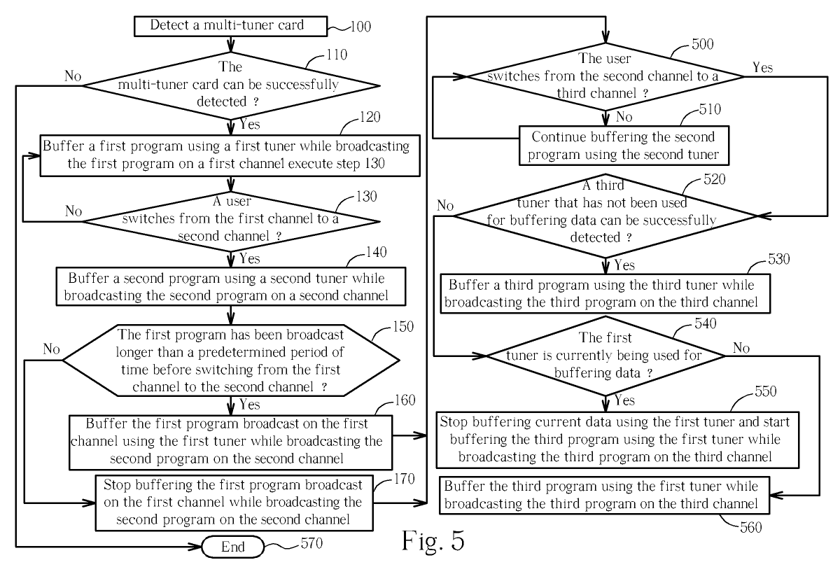

Reference is made to FIG. 5 for a flowchart illustrating a method for managing time-shifting among a plurality of channels using a plurality of tuners according to a third embodiment of the present invention. The flowchart in FIG. 5 includes the following steps:

Step 100: detect a multi-tuner card capable of controlling a plurality of tuners.

Step 110: determine whether the multi-tuner card can be successfully detected: if the multi-tuner card can be successfully detected, execute step 120; if the multi-tuner card cannot be successfully detected, execute step 570.

Step 120: buffer a first program using a first tuner while broadcasting the first program on a first channel; execute step 130.

Step 130: determine whether a user switches from the first channel to a second channel: if the user switches from the first channel to the second channel, execute step 140; if the user does not switch from the first channel to the second channel, execute step 120.

Step 140: buffer a second program using a second tuner while broadcasting the second program on a second channel; execute step 150.

Step 150: determine whether the first program has been broadcast longer than a predetermined period of time before switching from the first channel to the second channel: if the first program has been broadcast longer than the predetermined period of time before switching channels, execute step 160; if the first program has not been broadcast longer than the predetermined period of time before switching channels, execute step 170.

Step 160: buffer the first program broadcast on the first channel using the first tuner while broadcasting the second program on the second channel, execute step 500.

Step 170: stop buffering the first program broadcast on the first channel while broadcasting the second program on the second channel, execute step 500.

Step 500: determine whether the user switches from the second channel to a third channel: if the user switches from the second channel to the third channel, execute step 520; if the user does not switch from the second channel to the third channel, execute step 510.

Step 510: continue buffering the second program using the second tuner; execute step 500.

Step 520: determine whether a third tuner that has not been used for buffering data can be successfully detected: if the third tuner can be successfully detected, execute step 530; if the third tuner cannot be successfully detected, execute step 540.

Step 530: buffer a third program using the third tuner while broadcasting the third program on the third channel, execute step 500.

Step 540: determine whether the first tuner is currently being used for buffering data: if the first tuner is being used for buffering data, execute step 550; if the first tuner is not being used for buffering data, execute step 560.

Step 550: stop buffering current data using the first tuner and start buffering the third program using the first tuner while broadcasting the third program on the third channel.

Step 560: buffer the third program using the first tuner while broadcasting the third program on the third channel.

Step 570: end.

Steps 100-170 of the third embodiment of the present invention, similar to those of the first embodiment of the present invention, illustrate the method for performing time-shifting when the user switches from the first channel to the second channel. After executing step 160 or 170, it is determined in step 500 whether the user switches channels again. If the user switches from the second channel to the third channel, it is determined in step 520 whether a third tuner that has not been used for buffering data can be successfully detected. If the video recorder includes more than two tuners, an unused third tuner can be detected, and step 530 will be executed for buffering the third program broadcast on the third channel. If the video recorder only includes two tuners, it is determined in step 540 whether the first tuner is buffering data. If it is determined in step 150 that the first program has not been broadcast longer than the predetermined period of time before switching to the second channel, step 170 will be executed in order to stop buffering the first program using the first tuner. Under these circumstances, it will be determined in step 540 that the first tuner is not used for performing time-shifting at the moment, and step 560 will be executed for buffering the third program using the first tuner while broadcasting the third program on the third channel. On the contrary, if it is determined in step 150 that the first program has been broadcast longer than the predetermined period of time before switching to the second channel, step 160 will be executed in order to continue buffering the first program using the first tuner. Under these circumstances, it will be determined in step 540 that the first tuner is being used for performing time-shifting at the moment, and step 550 will be executed for ending the current time-shifting of the first tuner. Then, the first tuner can be used for buffering the third program broadcast on the third channel.

The third embodiment of the present invention further includes step 540 that determines whether free tuners are available. When the user switches channels, a video recorder having N tuners can only perform time-shifting on N different channels simultaneously. When the user switches channels for the (N+1)ₜₕ time, all of the N tuners have been used for performing time-shifting. If the third embodiment of the present invention does not need to perform time-shifting on an original channel each time after switching to a new channel, free tuners can be detected and step 560 is executed for performing time-shifting on the newest channel using a free tuner. On the other hand, if the third embodiment of the present invention is required to perform time-shifting on an original channel each time after switching to a new channel, all of the N tuners are being used for performing time-shifting. In this case, the third embodiment of the present invention ends the current operation of a tuner and starts to perform time-shifting on the newest channel using the tuner.

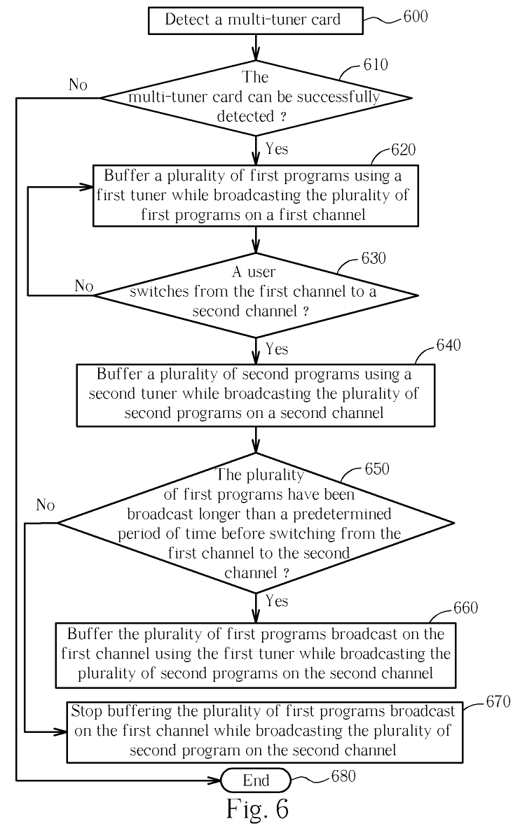

Reference is made to FIG. 6 for a flowchart illustrating a method for managing time-shifting using two tuners according to a fourth embodiment of the present invention. The flowchart in FIG. 6 includes the following steps:

Step 600: detect a multi-tuner card capable of controlling a plurality of tuners.

Step 610: determine whether the multi-tuner card can be successfully detected: if the multi-tuner card can be successfully detected, execute step 620; if the multi-tuner card cannot be successfully detected, execute step 680.

Step 620: buffer a plurality of first programs using a first tuner while broadcasting the plurality of first programs on a first channel; execute step 630.

Step 630: determine whether a user switches from the first channel to a second channel: if the user switches from the first channel to the second channel, execute step 640; if the user does not switch from the first channel to the second channel, execute step 620.

Step 640: buffer a plurality of second programs using a second tuner while broadcasting the plurality of second programs on a second channel; execute step 650.

Step 650: determine whether the plurality of first programs have been broadcast longer than a predetermined period of time before switching from the first channel to the second channel: if the plurality of first programs have been broadcast longer than the predetermined period of time before switching channels, execute step 660; if the plurality of first programs have not been broadcast longer than the predetermined period of time before switching channels, execute step 670.

Step 660: buffer the plurality of first programs broadcast on the first channel using the first tuner while broadcasting the plurality of second programs on the second channel.

Step 670: stop buffering the plurality of first programs broadcast on the first channel while broadcasting the plurality of second program on the second channel.

Step 680: end.

The fourth embodiment of the present invention can be applied to a dual-tuner digital video recorder. Since a digital video recorder can transmit a plurality of programs using the same frequency simultaneously, the present invention can buffer all digital programs broadcast on the same channel at the same time. In addition, the present invention can be applied to multi-tuner digital video recorders, as illustrated in the second and third embodiments of the present invention.

The present invention can be applied to dual-tuner or multi-tuner analog/digital video recorders. It is determined whether time-shifting should still be performed on an original channel after switching to a new channel based on how long the original channel has been broadcasting programs before switching channels. Therefore, even if the user keeps switching channels, the user can still retrieve contents of the programs that have been previously broadcast on the time-shifting channels, as well as execute operations such as rewind, fast-rewind, pause or play on the retrieved contents of the program.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for managing time-shifting among a plurality of channels comprising:
buffering a first program using a first tuner while broadcasting the first program on a first channel;
buffering a second program using a second tuner while broadcasting the second program on a second channel after switching from the first channel to the second channel;
determining whether the first program has been broadcast longer than a predetermined period of time; and
buffering the first program using the first tuner while broadcasting the second program on the second channel if the first program has been broadcast longer than the predetermined period of time before switching from the first channel to the second channel.

2. The method of claim 1 further comprising:
accessing data related to the first program from the first tuner after switching from the second channel back to the first channel.

3. The method of claim 1 further comprising:
activating the first tuner for buffering the first program; and
activating the second tuner for buffering the second program.

4. The method of claim 1 further comprising:
de-activating the first tuner in order to stop buffering the first program if the first program has not been broadcast longer than the predetermined period of time before switching from the first channel to the second channel.

5. The method of claim 4 further comprising:
buffering a third program using the first tuner while broadcasting the third program on a third channel after switching from the second channel to the third channel.

6. The method of claim 1 further comprising:
buffering a third program using a third tuner while broadcasting the third program on a third channel after switching from the second channel to the third channel.

7. The method of claim 6 further comprising: detecting a multi-tuner card capable of controlling the third tuner.

8. The method of claim 1 further comprising:
detecting a multi-tuner card capable of controlling the first and second tuners.

9. The method of claim 1 further comprising:
buffering a plurality of first programs using the first tuner while broadcasting the plurality of first programs on the first channel;
buffering a plurality of second programs using the second tuner while broadcasting the plurality of second programs on the second channel after switching from the first channel to the second channel;
determining whether the plurality of first programs have been broadcast longer than the predetermined period of time before switching from the first channel to the second channel; and
buffering the plurality of first programs using the first tuner while broadcasting the plurality of second programs on the second channel if the plurality first programs have been broadcast longer than the predetermined period of time before switching from the first channel to the second channel.

10. A multi-media display system capable of managing time-shifting among a plurality of channels comprising:
a broadcasting means for broadcasting programs on a plurality of channels;
a first buffering means for buffering a first program broadcast on a first channel;
a second buffering means for buffering a second program broadcast on a second channel;
a judging means for determining whether the first program has been broadcast longer than a predetermined period of time before switching from the first channel to the second channel; and
a control means for activating the first buffering means in order to buffer the first program after switching from the first channel to the second channel if the first program has been broadcast longer than the predetermined period of time before switching from the first channel to the second channel.

11. The multi-media display system of claim 10 wherein the control means deactivates the first buffering means in order to stop buffering the first program after switching from the first channel to the second channel if the first program has not been broadcast longer than the predetermined period of time before switching from the first channel to the second channel.

12. The multi-media display system of claim 10 further comprising:
a driving means for driving the first and second buffering means.

13. The multi-media display system of claim 10 wherein the first and second buffering means include tuners.

14. The multi-media display system of claim 13 wherein the driving means includes a multi-tuner card.
